(19) United States
(12) Patent Application Publication
(10) Pub. No.: US 2023/0113911 A1
(43) Pub. Date: Apr. 13, 2023

(54) SIGNAL TRANSFER SYSTEM, SIGNAL TRANSFER DEVICE, SIGNAL TRANSFER METHOD AND SIGNAL TRANSFER PROGRAM

(71) Applicant: NIPPON TELEGRAPH AND TELEPHONE CORPORATION, Tokyo (JP)

(72) Inventors: Hiroko NOMURA, Musashino-shi, Tokyo (JP); Naotaka SHIBATA, Musashino-shi, Tokyo (JP); Keita TAKAHASHI, Musashino-shi, Tokyo (JP); Tomoya HATANO, Musashino-shi, Tokyo (JP)

(73) Assignee: NIPPON TELEGRAPH AND TELEPHONE CORPORATION, Tokyo (JP)

(21) Appl. No.: 17/907,958

(22) PCT Filed: Mar. 9, 2020
(86) PCT No.: PCT/JP2020/010096

§ 371 Date: Aug. 29, 2022

(51) Int. Cl. H04W 28/02; H04W 24/08

(52) U.S. Cl. CPC H04W 28/0252; H04W 24/08

(57) ABSTRACT

In a signal transfer system including a signal transfer management apparatus and a plurality of signal transfer apparatuses connected in multiple stages that form a network between distribution station apparatuses and a central station apparatus, a first signal transfer apparatus directly connected to a distribution station apparatus among the plurality of signal transfer apparatuses acquires the amount of data of a high priority signal that will be output next from the distribution station apparatus, measures the amount of traffic of the high priority signal received from the distribution station apparatus, calculates opening and closing timings of a gate for transferring a low priority signal based on the amount of data and the amount of traffic, and opens and closes the gate for transferring the low priority signal. This enables efficient use of the network bandwidth.

### TECHNICAL FIELD

The present invention relates to a signal transfer technique that uses a time aware shaper (TAS) function.

### BACKGROUND ART

Networks that make up a cellular system include those of mobile fronthaul (MFH) and mobile backhaul (MBH). MBH is a network between distribution station apparatuses corresponding to base stations and a centralized station that controls the distribution station apparatuses. On the other hand, MFH corresponds to the section between a wireless control apparatus and wireless apparatuses when a base station is configured with its components deployed separately over the wireless control apparatus and the wireless apparatuses. In the related art, point-to-point connections have been used for this section, while implementation of a network with a configuration in which layer-2 switches are connected in multiple stages has also been considered (see NPL 1), which achieves efficient accommodation compared to point-to-point connections. In such networks, it is necessary to satisfy strict delay requirements, and in order to reduce the delay of high priority signals, it has been proposed that each signal transfer apparatus be equipped with a TAS function.

Hereinafter, the present invention will be described with reference to MBH as an example, but can also be applied to MFH by replacing distribution station apparatuses with wireless apparatuses and a central station apparatus with a wireless control apparatus.

### CITATION LIST

### Non Patent Literature

NPL 1: “Time-Sensitive Networking for Fronthaul,” IEEE Std P802. 1CM, May 7, 2018

### SUMMARY OF THE INVENTION

### Technical Problem

The TAS reserves a time slot for a high priority signal and opens a gate in the reserved time slot to transfer the signal while closing gates of other priority signals, such that high priority signals are transferred preferentially. However, in the TAS in the related art, even when the amount of traffic of a high priority signal is small, other priority signals are not transferred because a reserved gate length for a high priority signal is constant regardless of the amount of traffic of the high priority signal and thus there is a problem that the use efficiency of the network bandwidth is reduced.

It is an object of the present invention to provide a signal transfer system, a signal transfer apparatus, a signal transfer method, and a signal transfer program that can improve bandwidth use efficiency by opening the gate of a low priority signal based on the amount of data of a high priority signal included in mobile scheduling information received from a distribution station apparatus and the amount of traffic of a high priority signal actually received from the distribution station apparatus.

### Means for Solving the Problem

The present invention provides a signal transfer system including a distribution station apparatus corresponding to a wireless base station apparatus, a central station apparatus that centrally controls the wireless base station apparatus, a plurality of signal transfer apparatuses connected in multiple stages and forming a network between the distribution station apparatus and the central station apparatus, and a signal transfer management apparatus that controls the plurality of signal transfer apparatuses, wherein a first signal transfer apparatus directly connected to the distribution station apparatus among the plurality of signal transfer apparatuses acquires an amount of data of a high priority signal that is to be output next from the distribution station apparatus, measures an amount of traffic of the high priority signal received from the distribution station apparatus, calculates opening and closing timings of a gate for transferring a low priority signal based on the amount of data and the amount of traffic, and opens and closes the gate for transferring the low priority signal based on a result of the calculation.

The present invention also provides a signal transfer apparatus forming a network between a distribution station apparatus corresponding to a wireless base station apparatus, a central station apparatus that centrally controls the wireless base station apparatus, the distribution station apparatus, and the central station apparatus, the signal transfer apparatus including a cooperation interface that acquires, when the signal transfer apparatus is directly connected to the distribution station apparatus, an amount of data of a high priority signal that is to be output next from the distribution station apparatus, a counter unit that measures an amount of traffic of the high priority signal received from the distribution station apparatus, a calculation unit that calculates opening and closing timings of a gate for transferring a low priority signal based on the amount of data and the amount of traffic, and a scheduler unit that opens and closes the gate for transferring the low priority signal based on a result of the calculation of the calculation unit.

The present invention also provides a signal transfer method for a signal transfer system including a distribution station apparatus corresponding to a wireless base station apparatus, a central station apparatus that centrally controls the wireless base station apparatus, a plurality of signal transfer apparatuses connected in multiple stages and forming a network between the distribution station apparatus and the central station apparatus, and a signal transfer management apparatus that controls the plurality of signal transfer apparatuses, the signal transfer method including by a first signal transfer apparatus directly connected to the distribution station apparatus among the plurality of signal transfer apparatuses, acquiring an amount of data of a high priority signal that is to be output next from the distribution station apparatus, by the first signal transfer apparatus, measuring an amount of traffic of the high priority signal received from the distribution station apparatus, by the first signal transfer apparatus, calculating opening and closing timings of a gate for transferring a low priority signal based on the amount of data and the amount of traffic, and by the first signal transfer apparatus, opening and closing the gate for transferring the low priority signal based on a result of the calculation.

A signal transfer program according to the present invention causes a computer to execute processing performed in the signal transfer method.

### Effects of the Invention

The signal transfer system, the signal transfer apparatus, the signal transfer method, and the signal transfer program according to the present invention can improve bandwidth use efficiency by opening the gate of a low priority signal only for a necessary period based on the amount of data of a high priority signal included in mobile scheduling information received from a distribution station apparatus and the amount of traffic of a high priority signal actually received from the distribution station apparatus.

Further, the present invention can be applied to any traffic pattern regardless of whether traffic is in a burst or intermittent because control is performed using the amount of traffic.

### BRIEF DESCRIPTION OF DRAWINGS

FIG. 1 is a diagram illustrating an exemplary configuration of a signal transfer system according to the present embodiment.

FIG. 2 is a diagram illustrating an exemplary configuration of a signal transfer apparatus that is directly connected to a distribution station apparatus.

FIG. 3 is a diagram illustrating an exemplary configuration of a signal transfer apparatus that is not directly connected to a distribution station apparatus.

FIG. 4 is a diagram illustrating an exemplary configuration of a signal transfer apparatus of a comparative example.

### DESCRIPTION OF EMBODIMENTS

Hereinafter, an embodiment of a signal transfer system, a signal transfer apparatus, a signal transfer method, and a signal transfer program according to the present invention will be described with reference to the drawings. Each signal transfer apparatus described in the following embodiment corresponds to a network device such as a Layer-2 SWitch (L2SW) and the signal transfer management apparatus manages and controls the operation of signal transfer apparatuses.

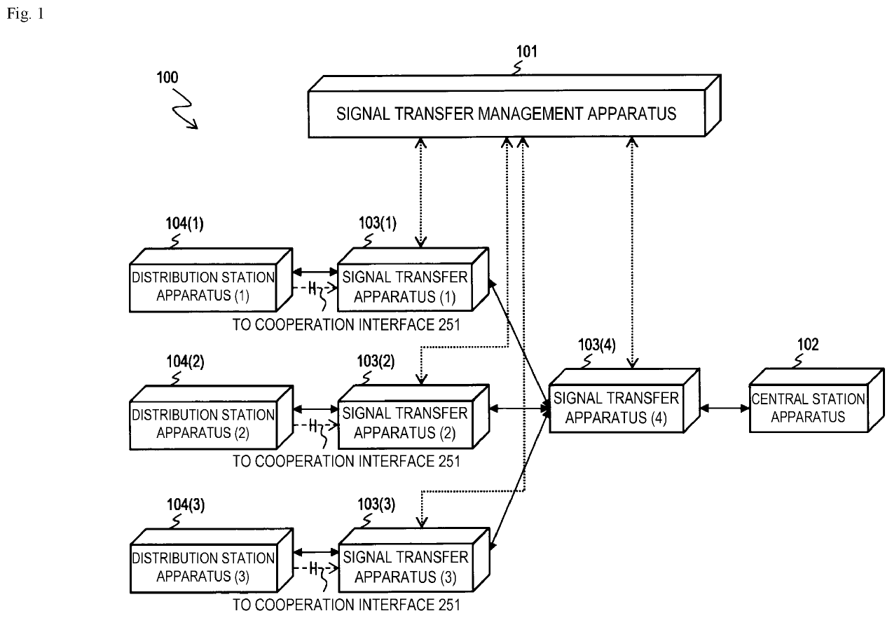

FIG. 1 illustrates an exemplary configuration of a signal transfer system 100 according to the present embodiment. In FIG. 1, the signal transfer system 100 includes a signal transfer management apparatus 101, a central station apparatus 102, a signal transfer apparatus 103(1), a signal transfer apparatus 103(2), a signal transfer apparatus 103(3), a signal transfer apparatus 103 (4), a distribution station apparatus 104(1), a distribution station apparatus 104(2), and a distribution station apparatus 104(3). Here, when a common description is given on the signal transfer apparatuses 103(1) to 103(4) in the following description, each will be referred to as a signal transfer apparatus 103 with “(number)” at the end of the reference sign omitted and the same applies to the distribution station apparatus 104(1) to 104(3).

In the signal transfer system 100 illustrated in FIG. 1, a plurality of signal transfer apparatuses 103 connected in multiple stages form a network between a plurality of distribution station apparatuses 104 and a central station apparatus 102 in a wireless base station apparatus that is deployed separately over the distribution station apparatuses 104 and the central station apparatus 102.

In FIG. 1, the distribution station apparatuses 104(1), 104(2), and 104(3) wirelessly communicate with wireless terminals (such as, for example, mobile terminals or IoT terminals) and high priority frames of communication signals are aggregated in the central station apparatus 102 via the network formed of the signal transfer apparatuses 103(1) to 103(4).

The central station apparatus 102 aggregates uplink signals from the plurality of distribution station apparatuses 104 via the network and distributes downlink signals to the distribution station apparatuses 104 via the network.

The signal transfer apparatuses 103 are apparatuses that transfer signals between the distribution station apparatuses 104 and the central station apparatus 102 and form the network. Although the network of FIG. 1 is illustrated as a star-type network, the present embodiment can be similarly applied to a ring-type network, a mesh-type network, or the like.

Here, in the following description, one side of the plurality of signal transfer apparatuses 103 connected in multiple stages which is closer to the distribution station apparatuses 104 is referred to as a lower side and the other side which is closer to the central station apparatus 102 is referred to as an upper side. Further, in the direction in which a signal flows, a stage from which the signal is transmitted is referred to as a previous stage and another stage at which the signal is received is referred to as a next stage. For example, in the case of FIG. 1, the signal transfer apparatuses 103(1), 103(2), and 103(3) are each a signal transfer apparatus 103 on the lower side in the uplink direction from the distribution station apparatuses 104 to the central station apparatus 102 and are each a signal transfer apparatus 103 at the previous stage to the signal transfer apparatus 103(4). Similarly, the signal transfer apparatus 103(4) is a signal transfer apparatus 103 on the upper side and a signal transfer apparatus 103 at the next stage to the signal transfer apparatuses 103(1), 103(2), and 103(3).

The example of FIG. 1 is provided with the signal transfer apparatuses 103(1), 103(2), and 103(3) on the lower side which are connected respectively to the distribution station apparatuses 104(1), 104(2), and 104(3) and the signal transfer apparatus 103(4) on the upper side that aggregates signals from the signal transfer apparatuses 103(1) to 103(3) and connects them to the central station apparatus 102. The signal transfer apparatuses 103(1), 103(2) and 103(3) are connected respectively to the distribution station apparatuses 104(1), 104(2) and 104(3) via dedicated cooperation interfaces (IFs) 251 and acquire mobile scheduling information from the distribution station apparatuses 104 through PUCCH signals. Here, the mobile scheduling information includes information regarding the transmission timing and the amount of data of each frame that will be transmitted from a distribution station apparatus 104 in the future. Each of the signal transfer apparatuses 103(1), 103(2), and 103(3), which are directly connected to the distribution station apparatuses 104 by the cooperation interfaces 251, corresponds to a first signal transfer apparatus and the signal transfer apparatus 103(4), which is not directly connected to a distribution station apparatus 104 by a cooperation interface 251, corresponds to a second signal transfer apparatus.

Each signal transfer apparatus 103 according to the present embodiment has functions of calculating the timings of opening and closing gates (opening and closing timings) of low priority frames based on the amount of data of a high priority frame included in mobile scheduling information that has been received from a distribution station apparatus 104 via a cooperation interface 251 and the amount of traffic of a high priority frame that has been actually received from the distribution station apparatus 104 and then opening the gates of low priority frames. Here, gates pass signals when they are open and blocks signals when they are closed.

In FIG. 1, the signal transfer management apparatus 101 determines paths through which signals are to be passed between the distribution station apparatuses 104 and the central station apparatus 102 in the network formed of the signal transfer apparatuses 103 and instructs each signal transfer apparatus 103 or instructs a scheduler unit 205 in each signal transfer apparatus 103.

Here, the signal transfer apparatuses 103 are each equipped with a TAS function because signals communicated between the distribution station apparatuses 104 and the central station apparatus 102 are required to have a low delay. In the following description, signals communicated between distribution station apparatuses 104 and the central station apparatus 102 are referred to as frames when it is specifically indicated, while signals and frames basically indicate the same.

As described in the related art, the TAS reserves a time slot for a frame with traffic with a high priority (a high priority frame) and opens a gate in the reserved time slot to transfer the high priority frame while closing gates of other priority frames. Thereby, high priority frames are transferred preferentially. However, in the TAS in the related art, even when the amount of traffic of a high priority frame is small, the gate is occupied and other priority frames are not transferred because a reserved gate length for a high priority frame is constant regardless of the amount of traffic of the high priority frame and thus there is a problem that the use efficiency of the network bandwidth is reduced.

Therefore, the signal transfer system 100 according to the present embodiment has functions of acquiring the amount of data of a high priority frame from mobile scheduling information output from a distribution station apparatus 104, determining the end of a high priority frame (the completion of the transmission section of a high priority frame) according to the amount of data, and opening a gate for another priority frame. Thus, the signal transfer system 100 according to the present embodiment prevents a high priority frame from occupying a gate when the amount of traffic of the high priority frame is small to enable transfer of other priority traffic, and thus can prevent a reduction in the use efficiency of the network bandwidth.

As described above, each signal transfer system 100 according to the present embodiment controls opening and closing timings of the gates of low priority frames based on mobile scheduling information that has been received from a distribution station apparatus 104 via a cooperation interface 251, such that efficient use of the network bandwidth can be achieved.

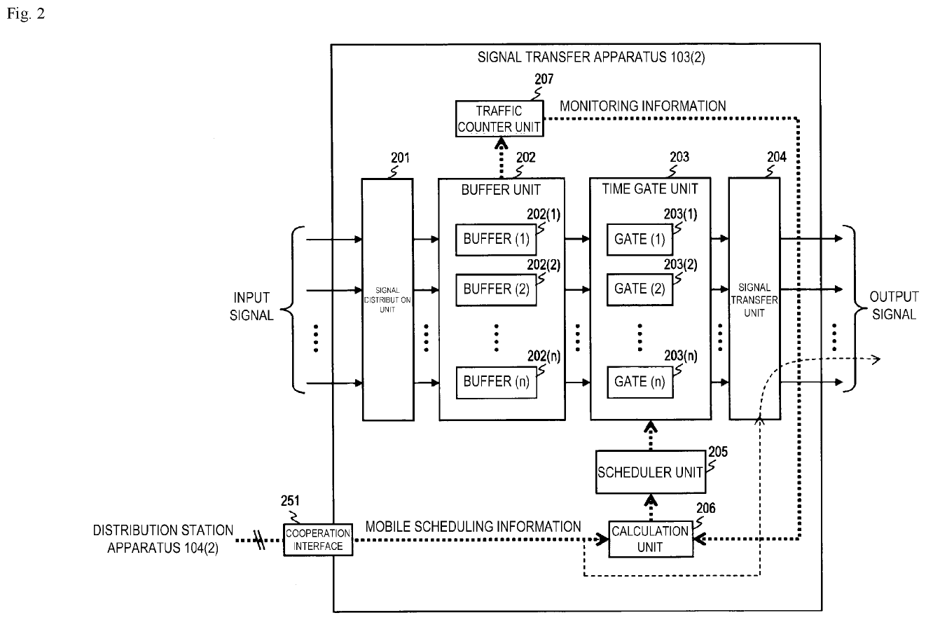

FIG. 2 illustrates an exemplary configuration of the signal transfer apparatus 103(2) that is directly connected to the distribution station apparatus 104(2). Although the signal transfer apparatus 103(2) will be described with reference to FIG. 2, the same applies to the signal transfer apparatus 103(1) and the signal transfer apparatus 103(3) that are directly connected to distribution station apparatuses 104.

In FIG. 2, the signal transfer apparatus 103(2) includes a signal distribution unit 201, a buffer unit 202, a time gate unit 203, a signal transfer unit 204, a scheduler unit 205, a calculation unit 206, a traffic counter unit 207, and a cooperation interface 251.

The signal distribution unit 201 has a function of distributing input signals to priority based buffers. For example, the signal distribution unit 201 distributes frames, which are received from a distribution station apparatus 104 or another signal transfer apparatus 103 when they are uplink or received from the central station apparatus 102 or another signal transfer apparatus 103 when they are downlink, based on priorities stored in their frame headers and outputs them to the buffer unit 202.

The buffer unit 202 is a buffer memory that temporarily holds high priority frames or low priority frames distributed by the signal distribution unit 201 according to their priorities. The buffer unit 202 includes a plurality of preset priority based buffers (such as, for example, high priority buffers and low priority buffers). In the example of FIG. 2, the buffer unit 202 includes n buffers 202(1), 202(2), . . . , and 202(n) (where n is a positive integer).

The time gate unit 203 includes a plurality of gates corresponding to the plurality of buffers of the buffer unit 202 and opens and closes the gates in response to commands from the scheduler unit 205. In the example of FIG. 2, the time gate unit 203 includes n gates 203(1), 203(2), . . . , 203(n). The time gate unit 203 controls opening and closing of the gates that output frames from the corresponding buffers in which the frames with corresponding priorities are held, for example, in response to commands from the scheduler unit 205.

The signal transfer unit 204 has a function of transferring frames output from the gates of the time gate unit 203 to output destinations designated based on commands from the signal transfer management apparatus 101 that will be described later.

The scheduler unit 205 controls whether to transmit signals held in the buffers of the buffer unit 202 by opening and closing the gates of the time gate unit 203 based on preset scheduling information. Here, the scheduling information is information regarding gate start times, gate open durations, gate opening cycles, or the like of the gates of the time gate unit 203 for the frames held in the priority based buffers of the buffer unit 202. In the present embodiment, the scheduling information of the scheduler unit 205 is adjusted based on a calculation result of the calculation unit 206, and thus the scheduler unit 205 can open and close the gates of low priority frames. When the scheduling information is not adjusted, the scheduler unit 205 periodically opens and closes each gate at a gate start time, a gate open duration, and a gate opening cycle that are predetermined according to the priority. When the scheduling information is not adjusted, each gate is periodically opened and closed at a gate start time, a gate open duration, and a gate opening cycle that are predetermined according to the priority. Here, in the present embodiment, information that has been received from the distribution station apparatus 104(2) via the cooperation interface 251 is referred to as mobile scheduling information and information used by the scheduler unit 205 is referred to as scheduling information.

The calculation unit 206 determines the end of a high priority frame (the completion of the transmission section of a high priority frame) based on the amount of traffic for each priority that passes through the buffer unit 202, which has been output by the traffic counter unit 207, and mobile scheduling information that has been received from the distribution station apparatus 104(2) via the cooperation interface 251 and calculates the opening and closing timings of the gate of a low priority frame. Here, the mobile scheduling information includes information on the amount of data of each high priority frame at intervals of 1 ms that will flow in from the distribution station apparatus 104(2) in the future. The calculation unit 206 compares the amount of data of a high priority included in the mobile scheduling information and the amount of traffic of a high priority frame measured by the traffic counter unit 207, and when the amount of traffic has become larger than the amount of data (that is, when the transmission of the high priority frame has been completed), issues an instruction to the scheduler unit 205 to close the gate of the high priority frame and open a gate for another priority frame. In order to deal with some errors, the calculation unit 206 may issue the instruction when a certain predetermined time has elapsed after the amount of traffic measured by the traffic counter unit 207 becomes larger than the amount of data rather than issuing the instruction immediately after the amount of traffic measured by the traffic counter unit 207 becomes larger than the amount of data.

The traffic counter unit 207 counts the amount of traffic of the buffer unit 202 for each priority. Then, the traffic counter unit 207 transmits the amount of traffic to the signal transfer management apparatus 101 as monitoring information and also outputs the amount of traffic to the calculation unit 206. Here, based on the mobile scheduling information, the traffic counter unit 207 clears, in accordance with the cycle of a high priority frame transmitted from the distribution station apparatus 104(2), the counter to zero at the beginning of the cycle and monitors the amount of traffic.

The cooperation interface 251 is a dedicated interface with the distribution station apparatus 104(2) and the signal transfer apparatus 103(2) receives mobile scheduling information from the distribution station apparatus 104(2) via the cooperation interface 251. In the present embodiment, the mobile scheduling information that has been received from the distribution station apparatus 104(2) is output to the calculation unit 206 via the discard unit 208. The cooperation interface 251 may not output the mobile scheduling information that has been received from the distribution station apparatus 104(2) to the calculation unit 206, but instead output the mobile scheduling information as it is from the signal transfer unit 204 to a signal transfer apparatus 103 at the next or later stage, skipping the calculation unit 206. In this case, the calculation unit 206 and the traffic counter unit 207 do not perform the operations described above and the scheduler unit 205 controls a time gate unit 203 based on preset scheduling information.

The signal transfer apparatus 103(2) that is directly connected to the distribution station apparatus 104(2) can improve bandwidth use efficiency by opening the gate of a low priority frame based on the amount of data of a high priority frame included in the mobile scheduling information that has been received from the distribution station apparatus 104(2) via the cooperation interface 251 and the amount of traffic of a high priority frame that has been actually received from the distribution station apparatus 104(2) in the above manner.

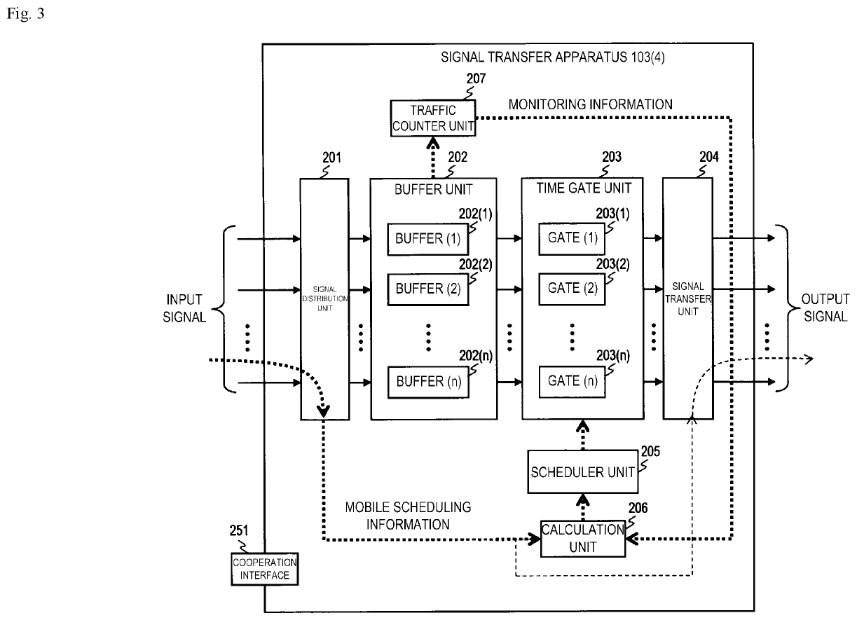

FIG. 3 illustrates an exemplary configuration of the signal transfer apparatus 103(4) that is not directly connected to a distribution station apparatus 104. In FIG. 3, the basic configuration of the signal transfer apparatus 103(4) is the same as that of the signal transfer apparatus 103 described with reference to FIG. 2. Although an example of the signal transfer apparatus 103(4) is illustrated in FIG. 3, the same is true when there is a signal transfer apparatus 103 at the next or later stage that is not directly connected to a distribution station apparatus 104 among the signal transfer apparatuses 103 connected in multiple stages.

In the signal transfer apparatus 103(4), a signal distribution unit 201 outputs mobile scheduling information that has been received from a signal transfer apparatus 103 at a previous stage (for example, the signal transfer apparatus 103(2)) to a calculation unit 206. Specifically, the signal transfer apparatus 103(4) receives mobile scheduling information transferred by the signal transfer apparatus 103(2) described with reference to FIG. 2 and outputs the received mobile scheduling information to the calculation unit 206. Here, the signal transfer apparatus 103(4) inputs the mobile scheduling information to the calculation unit 206, and when there is a signal transfer apparatus 103 at the next stage to that of the signal transfer apparatus 103(4) (when there is another signal transfer apparatus 103 between the signal transfer apparatus 103(4) and the central station apparatus 102 in the example of FIG. 1), may transfer the mobile scheduling information from a signal transfer unit 204 to the signal transfer apparatus 103 at the next stage. In the example of FIG. 3, the cooperation interface 251 of the signal transfer apparatus 103(4) is not connected to any of the distribution station apparatuses 104.

In FIG. 3, as described in FIG. 2, the traffic counter unit 207 monitors the status of traffic in a buffer unit 202 and counts the amount of traffic input to the buffer unit 202 for each priority.

The calculation unit 206 determines the end of a high priority frame based on the amount of traffic for each priority that passes through the buffer unit 202, which has been output by the traffic counter unit 207, and mobile scheduling information that has been received from the signal transfer apparatus 103(2) via the signal distribution unit 201. Specifically, the calculation unit 206 compares the amount of data of a high priority frame included in the mobile scheduling information received from the signal transfer apparatus 103(2) at the previous stage and the amount of traffic of a high priority frame measured by the traffic counter unit 207, and when the amount of traffic has become larger than the amount of data (that is, when the transmission of the high priority frame has been completed), issues an instruction to the scheduler unit 205 to close the gate of the high priority frame and open a gate for another priority frame. In order to deal with some errors, the calculation unit 206 may issue the instruction when a certain predetermined time has elapsed after the amount of traffic measured by the traffic counter unit 207 becomes larger than the amount of data rather than issuing the instruction immediately after the amount of traffic measured by the traffic counter unit 207 becomes larger than the amount of data as described with reference to FIG. 2.

The signal transfer apparatus 103(4) that is not directly connected to a distribution station apparatus 104 can improve bandwidth use efficiency by opening the gate of a low priority frame based on the amount of data of a high priority frame included in the mobile scheduling information received from the signal transfer apparatus 103(2) at the previous stage and the amount of traffic of a high priority frame that has been actually received from the signal transfer apparatus 103(2) in the above manner.

In FIGS. 2 and 3, an example of transferring mobile scheduling information from the signal transfer apparatus 103(2) to the signal transfer apparatus 103(4) has been described, but when there are other signal transfer apparatuses 103 between the signal transfer apparatus 103(4) and the central station apparatus 102, mobile scheduling information is transferred from the signal transfer apparatus 103(4) to a signal transfer apparatus 103 at the next stage and the same processing is performed at the signal transfer apparatus at the next stage.

Although the above embodiment has been described assuming that it is applied to MBH, it can also be applied to MFH. In the case of MFH, the distribution station apparatuses 104 are replaced with wireless apparatuses and the central station apparatus 102 is replaced with a wireless control apparatus, and the wireless apparatuses and the wireless control apparatus share and execute the functions of one base station. This sharing scheme makes a difference, and when a MAC layer that is considered to output mobile scheduling information is present on the wireless apparatus side, an implementation is possible with the same configuration as in FIG. 1. In the sharing case where a MAC layer that is considered to output mobile scheduling information is present on the wireless control apparatus side, a cooperation interface for receiving the mobile scheduling information needs to be provided between the central station apparatus 102 and the signal transfer apparatus 103(4). In this case, because mobile scheduling information of each of the distribution station apparatuses 104(1) to 104(3) can be received, the signal transfer apparatus 103(4) transfers the mobile scheduling information of the distribution station apparatus 104(1) to the signal transfer apparatus 103(1), the mobile scheduling information of the distribution station apparatus 104(2) to the signal transfer apparatus 103(2), and the mobile scheduling information of the distribution station apparatus 104(3) to the signal transfer apparatus 103(3).

When it is found from the mobile scheduling information that a high priority frame does not come in the next cycle, the signal transfer management apparatus 101 does not need to receive monitoring information from the traffic counter unit 207 and can issue an instruction not to close the gates of low priority frames to the scheduler unit 205.

### COMPARATIVE EXAMPLE

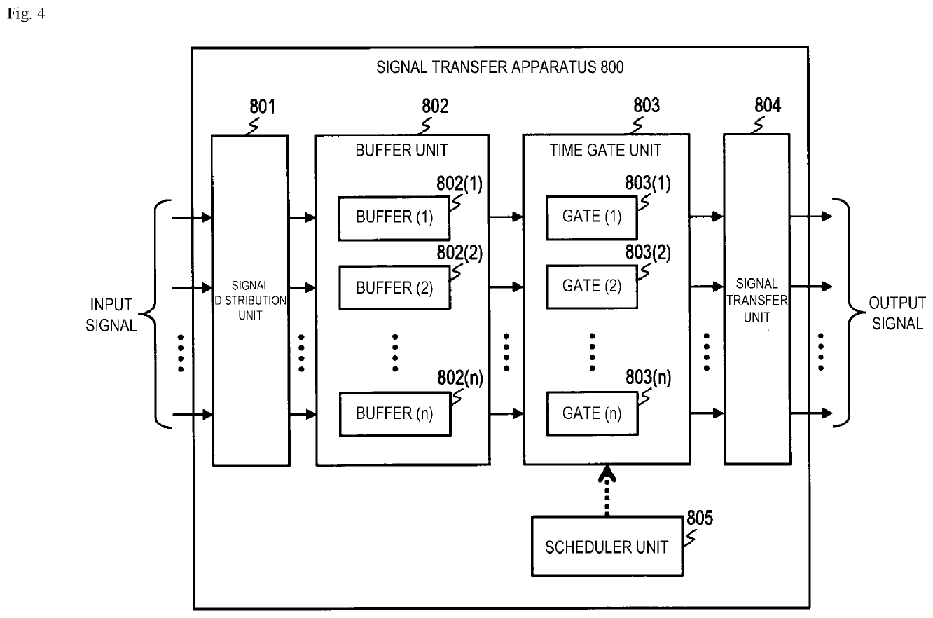

FIG. 4 illustrates an exemplary configuration of a signal transfer apparatus 800 of a comparative example. In FIG. 4, the signal transfer apparatus 800 includes a signal distribution unit 801, a buffer unit 802, a time gate unit 803, a signal transfer unit 804, and a scheduler unit 805. The signal transfer apparatus 800 has a TAS function and controls the opening and closing of each gate according to the priority.

Similar to the signal distribution unit 201 according to the present embodiment, the signal distribution unit 801 has a function of distributing input signals to priority based buffers.

Similar to the buffer unit 202 according to the present embodiment, the buffer unit 802 is a buffer memory that temporarily holds high priority frames or low priority frames distributed by the signal distribution unit 801 according to their priorities. In the example of FIG. 4, the buffer unit 802 has n buffers 802(1), 802(2), . . . , 802(n).

Similar to the time gate unit 203 according to the present embodiment, the time gate unit 803 includes a plurality of gates corresponding to the plurality of buffers of the buffer unit 802 and opens and closes the gates in response to commands from the scheduler unit 805. In the example of FIG. 4, the time gate unit 803 has n gates 803(1), 803(2), . . . , 803(n).

The signal transfer unit 804 has a function of transferring frames output from the gates of the time gate unit 803 to output destinations designated by the signal transfer management apparatus 101.

The scheduler unit 805 periodically opens and closes each gate at the gate start time, the gate open duration, and the gate opening cycle according to the priority based on predetermined scheduling information and preferentially transfers high priority frames.

Thus, through the TAS function, the signal transfer apparatus 800 reserves a time slot for a high priority frame and opens a gate in the reserved time slot to transfer the high priority frame while closing the gates of other priority frames, such that high priority frames can be transferred preferentially. However, in the signal transfer apparatus 800 of the comparative example, even when the amount of traffic of a high priority frame is small, the gate is occupied and other priority frames are not transferred because a reserved gate length (gate open duration) for a high priority frame is constant regardless of the amount of traffic of the high priority frame and thus there is a problem that the use efficiency of the network bandwidth is reduced.

On the other hand, the signal transfer apparatus 103 according to the present embodiment opens the gate of a low priority frame based on the amount of data of a high priority frame included in mobile scheduling information that has been received from a distribution station apparatus 104 via a cooperation interface 251 and the amount of traffic of a high priority frame that has been actually received from the distribution station apparatus 104, thereby enabling transfer of other priority frames, such that the bandwidth use efficiency can be improved.

As described above in the embodiment, the signal transfer system, the signal transfer apparatus, the signal transfer method, and the signal transfer program according to the present invention can improve the bandwidth use efficiency by opening the gate of a low priority signal based on the amount of data of a high priority signal included in mobile scheduling information received from a distribution station apparatus and the amount of traffic of a high priority signal actually received from the distribution station apparatus.

Here, the present embodiment has been described with reference to apparatuses with blocks illustrated in FIGS. 2 and 3, but it can also be realized by a computer that executes a program of a signal transfer method corresponding to processing performed by each block. The program may be recorded on a recording medium to be provided or may be provided through a network.

### REFERENCE SIGNS LIST

100 Signal transfer system
101 Signal transfer management apparatus
102 Central station apparatus
103, 800 Signal transfer apparatus
104 Distribution station apparatus
201, 801 Signal distribution unit
202, 802 Buffer unit
203, 803 Time gate unit
204, 804 Signal transfer unit
205, 805 Scheduler unit
206 Calculation unit
207 Traffic counter unit
251 Cooperation interface

1. A signal transfer system comprising:
a distribution station apparatus corresponding to a wireless base station apparatus;
a central station apparatus configured to centrally control the wireless base station apparatus;
a plurality of signal transfer apparatuses connected in multiple stages and forming a network between the distribution station apparatus and the central station apparatus; and
a signal transfer management apparatus configured to control the plurality of signal transfer apparatuses, wherein
a first signal transfer apparatus directly connected to the distribution station apparatus among the plurality of signal transfer apparatuses is configured to acquire an amount of data of a high priority signal that is to be output next from the distribution station apparatus, measure an amount of traffic of the high priority signal received from the distribution station apparatus, calculate opening and closing timings of a gate configured to transfer a low priority signal based on the amount of data and the amount of traffic, and open and close the gate configured to transfer the low priority signal based on a result of the calculation.

2. The signal transfer system according to claim 1, wherein
the first signal transfer apparatus directly connected to the distribution station apparatus among the plurality of signal transfer apparatuses is configured to transfer the amount of data acquired from the distribution station apparatus to a second signal transfer apparatus not directly connected to the distribution station apparatus, and
the second signal transfer apparatus is configured to measure an amount of traffic of the high priority signal received from the first signal transfer apparatus, calculate opening and closing timings of a gate configured to transfer the low priority signal based on the amount of data and the amount of traffic, and open and close the gate configured to transfer the low priority signal based on a result of the calculation.

3. A signal transfer apparatus forming a network between a distribution station apparatus corresponding to a wireless base station apparatus, a central station apparatus configured to centrally control the wireless base station apparatus, the distribution station apparatus, and the central station apparatus, the signal transfer apparatus comprising:
a cooperation interface configured to, when the signal transfer apparatus is directly connected to the distribution station apparatus, acquire an amount of data of a high priority signal that is to be output next from the distribution station apparatus;
a processor; and
a storage medium having computer program instructions stored thereon, when executed by the processor, perform to:
measure an amount of traffic of the high priority signal received from the distribution station apparatus;
calculate opening and closing timings of a gate configured to transfer a low priority signal based on the amount of data and the amount of traffic; and
open and close the gate configured to transfer the low priority signal based on a result of the calculation of the calculation unit.

4. The signal transfer apparatus according to claim 3, wherein
the cooperation interface is configured to, when the signal transfer apparatus is directly connected to the distribution station apparatus, acquire the amount of data of the high priority signal that is to be output next from the distribution station apparatus and transfer the acquired amount of data to a signal transfer apparatus at a next or later stage, and
wherein the computer program instructions further perform to, when the signal transfer apparatus is not directly connected to the distribution station apparatus, calculate opening and closing timings of the gate configured to transfer the low priority signal based on the amount of data transferred from the signal transfer apparatus at a previous stage and the amount of traffic and open and close the gate configured to transfer the low priority signal based on a result of the calculation.

5. A signal transfer method for a signal transfer system including a distribution station apparatus corresponding to a wireless base station apparatus, a central station apparatus configured to centrally control the wireless base station apparatus, a plurality of signal transfer apparatuses connected in multiple stages and forming a network between the distribution station apparatus and the central station apparatus, and a signal transfer management apparatus configured to control the plurality of signal transfer apparatuses, the signal transfer method comprising:
by a first signal transfer apparatus directly connected to the distribution station apparatus among the plurality of signal transfer apparatuses, acquiring an amount of data of a high priority signal that is to be output next from the distribution station apparatus;
by the first signal transfer apparatus, measuring an amount of traffic of the high priority signal received from the distribution station apparatus;
by the first signal transfer apparatus, calculating opening and closing timings of a gate configured to transfer a low priority signal based on the amount of data and the amount of traffic; and
by the first signal transfer apparatus, opening and closing the gate configured to transfer the low priority signal based on a result of the calculation.

5. The signal transfer method according to claim 5, further comprising:
by the first signal transfer apparatus directly connected to the distribution station apparatus among the plurality of signal transfer apparatuses, transferring the amount of data acquired from the distribution station apparatus to a second signal transfer apparatus not directly connected to the distribution station apparatus,
by the second signal transfer apparatus, measuring an amount of traffic of the high priority signal received from the first signal transfer apparatus;
by the second signal transfer apparatus, calculating opening and closing timings of a gate configured to transfer the low priority signal based on the amount of data and the amount of traffic; and
by the second signal transfer apparatus, opening and closing the gate configured to transfer the low priority signal based on a result of the calculation.

7. A non-transitory computer-readable medium having computer-executable instructions that, upon execution of the instructions by a processor of a computer, cause the computer to function as the signal transfer method according to claim 5.
